(19) United States
(12) Patent Application Publication
(10) Pub. No.: US 2004/0093314 A1
(43) Pub. Date: May 13, 2004

(54) Method and device for receiving articles

(76) Inventor: Lee MacKlin, Colorado Springs, CO (US)

Correspondence Address: HEWLETT-PACKARD COMPANY, Intellectual Property Administration, P.O. Box 272400, Fort Collins, CO, 80527-2400, US

(21) Appl. No.: 10/291,135

(22) Filed: Nov. 8, 2002

(51) Int. Cl. G06F 17/60; G06F 17/00

(52) U.S. Cl. 705/406; 705/402

(57) ABSTRACT

A method for receiving articles in which a deposited article is maintained in a quarantine holding area and an element of identity indicia is received from an individual depositing the article. A tracking number is associated with the deposited article and the received identity indicia. A record of the tracking number and the associated identity indicia are maintained for a suitable archival interval. The method may be accomplished at a suitably configured device.

### BACKGROUND

The efficient movement of articles through governmental postal services as well as private couriers is desirable and necessary for the safe and efficient function of a country's economy and various activities and endeavors. Concerns about deposit and transport of hazardous biomaterials and chemical compounds through the mail have necessitated careful reexamination of mail deposit and transport procedures. Devices and methodologies which facilitate safe and efficient transport of postal articles through either government postal systems or private courier services would be highly desirable.

Heretofore, various devices have been proposed for preventing vandalism to mailboxes and other depository mechanisms. However, the need for a comprehensive device and methodology for tracking deposited mail and addressing concerns regarding the deposit of hazardous biomaterials, chemical compounds and the like is largely unmet.

### SUMMARY

Disclosed is a method and device for receiving mail in which a piece of received mail is maintained in a quarantined holding area while at least one element of identity indicia from the individual depositing the piece of mail is obtained from the individual and associated with the item of deposited mail. A tracking number is associated with both the identity indicia and the deposited mail and is maintained as a record of the transaction for a suitable archival interval. The method can be accomplished through the use of a mail depository kiosk which includes the mail quarantine holding area and an appropriate device for receiving identity indicia of the user and associating the received indicia with a suitable tracking number which is also assigned to the piece of deposited mail.

### DESCRIPTION OF THE DRAWINGS

FIG. 1 is a process diagram outlining a self-authenticating article receiving method;

FIG. 2 is a detail process diagram outlining a self-authenticating method for receiving articles; and

FIG. 3 is a schematic diagram of a representative mail depository kiosk.

### DESCRIPTION OF AN EMBODIMENT OF THE PRESENT INVENTION

The following is a detailed description of a best mode of the apparatus and carrying out the method outlined herein. This description is not to be taken in a limiting sense, but is made merely for purposes of illustrating the general principles disclosed herein.

Described below is a self-authenticating method for receiving articles such as which can be employed to address and/or minimize hazards associated with the receipt and transport of articles which may contain undesirable materials such as biohazards, chemical hazards, public safety hazards and the like. The self-authenticating method and device for receiving articles such as mail can also be employed to assist in routing and tracking deposited articles as well as providing reception locations which can be remote from post offices and the like thereby reducing congestion at post office service counters or other receiving locations. It is contemplated that the self-authenticating method for receiving articles such as mail can be employed with systems involving the receipt and distribution of traditional mail such as letters and packages routinely transported through government-sponsored mail transport services such as the United States Postal Services. It is also contemplated that the self-authenticating method and device for receiving articles may be efficaciously employed for use in private parcel and package delivery services. Finally, it is contemplated that the self-authenticating method and device for receiving articles such as mail could support a multi-modal method and device in which a user can designate the delivery service desired from various options provided.

In the method and device as disclosed, the term “mail” is defined as tangible or physical articles which are subject to any form of surface or air transportation. These articles can include conventional letters as well as larger parcels and packages. The maximum size of an article of mail will be a function of the ultimate dimensions of the receiving device employed as well as the limitations or regulations imposed by the governmental or private carrier. Where the term “mail” is employed, it is contemplated that the mail can be an individual piece of deposited mail or a plurality of pieces which can be iteratively or collectively received in the device and/or processed according to the method described herein.

The term “self-authenticating” is used herein to describe a process and device whereby the user provides assurance indicia which serves to diminish the hazard or threat associated with the deposit and receipt of anonymous mail.

In the self-authenticating method for receiving mail, a piece of deposited mail is maintained in a suitable quarantine holding area. While the mail is maintained in the holding area, an element of identity indicia is received from the individual depositing the piece of mail. A suitable tracking number or indicia is associated with the received identity indicia and the deposited mail. The tracking number is maintained with the deposited mail through subsequent processing and delivery. The tracking number is also maintained with the received identity indicia for a suitable archival interval. As used herein, the term “archival interval” is defined as an interval sufficient to permit delivery of the deposited mail to its ultimate destination and resolution of any potential hazards or concerns which may arise during or after the delivery process. The archival interval may be set to expire after the lapse of a predetermined interval measured from the time of deposit. Alternately, the archival interval may be set to expire after the lapse of a predetermined measured interval which occurs subsequent to unremarkable delivery of the deposited mail.

Upon the expiration of the archival interval, it is contemplated that associated identity indicia which has been maintained will be purged from the recorded data. It is contemplated that the archival interval will be sufficient to permit access and use of recorded identity indicia associated with a given tracking number in the event that the article of mail has been flagged as suspect or questionable subsequent to receipt and opening.

Useful identity indicia can include such information as inputted name, address, motor vehicle operator's license number and the like. For further accuracy and reliability, it is also contemplated that additional types or levels of identity indicia more uniquely linked to an individual can be employed. These can include, but are not limited to, fingerprint, retinal scan, key facial point scan, and the like. The method of the present invention contemplates that one or more of these elements can be used to formulate an identity indicia profile which can be associated with the tracking number assigned to a particular piece of deposited mail.

It is contemplated that the tracking number can be associated with the individual piece of deposited mail in any suitable fashion, such as a scannable bar code, alphanumeric characters or the like. The tracking number may be positioned appropriately on the piece of deposited mail in a manner which provides visual indication that the mail has passed security measures. It is contemplated that the identity indicia associated with the tracking number will be maintained in a manner which permits its release and use of identity indicia information in the event that abnormalities develop with regard to the piece of deposited mail. Thus various safeguards can be instituted to prevent the unauthorized release of identity indicia. It is also contemplated that the tracking number itself, without the associated identity indicia, can be employed by the individual depositing the mail as a receipt of mail deposit and as a method for assuring that the deposited mail has arrived at its intended destination.

The recorded identity indicia will be retained in association with the tracking indicia for a specified archival interval. At the expiration of the archival interval, once uneventful delivery and receipt of the article of mail has been accomplished, the data is purged as no longer relevant. In the event that a hazard is suspected or confirmed, the identity indicia associated with a given tracking number can be released to appropriate officials to assist in resolving the issue. Such information will be released in conformance with appropriate guidelines and applicable laws regarding privacy and law enforcement.

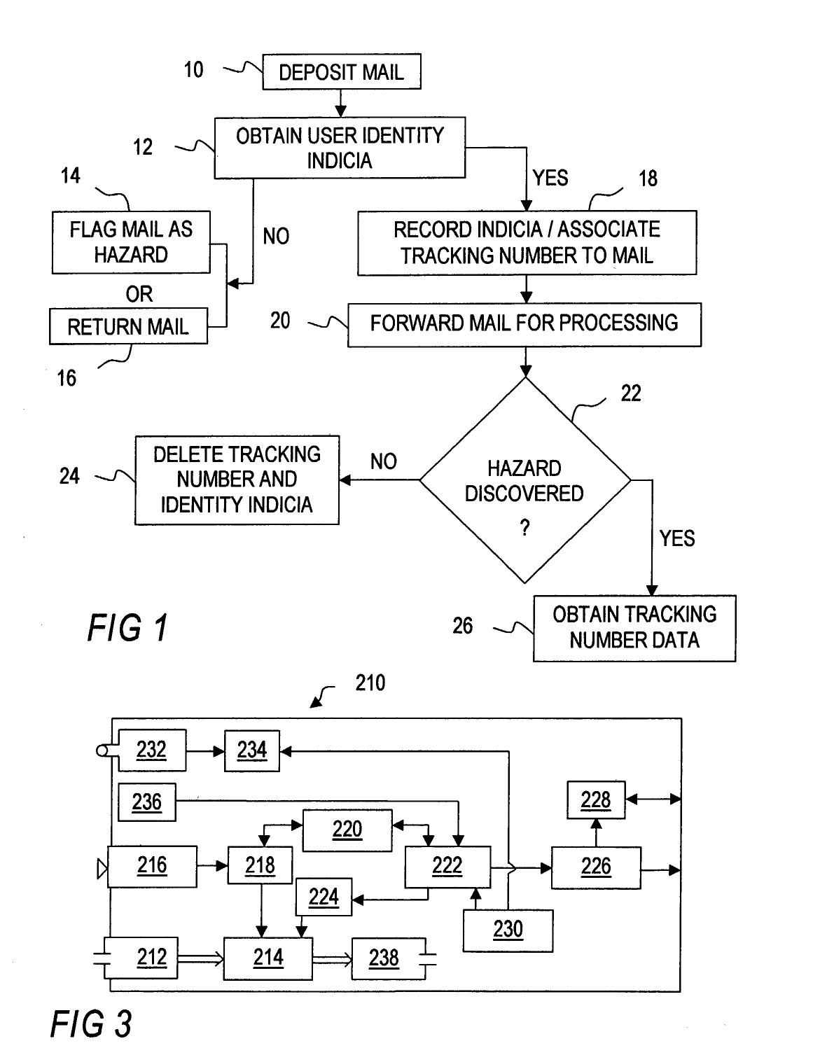

The self-authenticating method for receiving and processing mail is graphically depicted in FIG. 1. Mail is deposited in an appropriate mail-receiving kiosk as indicated at reference number 10. Deposit of a piece of mail initiates an appropriate prompt to obtain user identity indicia as indicated at reference numeral 12. The user identity indicia is provided by the individual depositing the piece of mail and can include data such as name, address, driver's license number and the like. As an additional security measure, the self-authenticating method of the present invention requires an additional user-specific identity indicia such as fingerprint, retinal scan or the like. If user-specific identity indicia is not obtained or provided, the deposited mail can be returned to the user as in step 14 or, alternately, the mail can be retained and flagged as hazardous for appropriate handling as desired or required as indicated at reference numeral 16.

When user and/or user-specific identity indicia is obtained successfully, it is contemplated that the identity indicia will be recorded and associated with a tracking number. The assigned tracking number will also be associated with deposited mail as indicated at reference numeral 18. The deposited mail with the associated tracking number can be forwarded for appropriate processing at reference numeral 20. The individual depositing the mail optionally may receive an appropriate indication that the transaction has been completed successfully. This indication can be a visual or audible indication and may, if desired, include a paper or electronic receipt which can be utilized to confirm deposit, track the deposited mail through transit and delivery, and confirm delivery of the deposited mail to the intended recipient.

The self-authenticating method for receiving mail also contemplates that the recorded user identity indicia will expire after a suitable archival interval. Such expiration will serve to address concerns about user privacy and misuse of received data. In order to facilitate the safety of the deposited mail, associated mail delivery system and intended recipients, it is contemplated that the record of identity indicia and associated tracking numbers will be maintained for a sufficient interval to assure that the piece of deposited mail has been received, opened and processed without adverse incident. Thus, optimally, the identity indicia will be maintained together with the associated tracking number for an interval beyond delivery which is sufficient to ensure incident free transit and delivery.

By way of non-limiting example, an attempt to mail a piece of mail carrying a biohazard such as anthrax using the self-authenticating mailing method could be made. The deposited mail containing the biohazard would be maintained in a quarantined holding area. The piece of mail could not be forwarded into the general mail delivery system until the depositor has provided identity indicia to be associated with a tracking number. In the optimum version of the present invention, the identity indicia would include data such as name and address as well as more unique and non-reproducible user-specific identifying indicia such as retinal scan or fingerprint. If the user does not submit the information, the deposited mail would be flagged as hazardous and handled accordingly, or in certain embodiments, the user would have the option of the mail's return.

Should the user submit identity indicia, the piece of deposited mail will be forwarded into the mail processing system with the associated tracking number. Either upon delivery or at any time during the mail processing operation, if evidence of the hazardous nature of the mail surfaces, the tracking number would be activated to access stored identity indicia to assist law enforcement personnel in identifying the individual who deposited the mail and assist in accessing and resolving the threat.

In addition to associating the piece of mail with appropriate identity indicia, it is also contemplated that the tracking number could be utilized to identify location of deposit and time of mail deposit which could further assist law enforcement personnel in identifying or isolating the perpetrator of the hazard or threat.

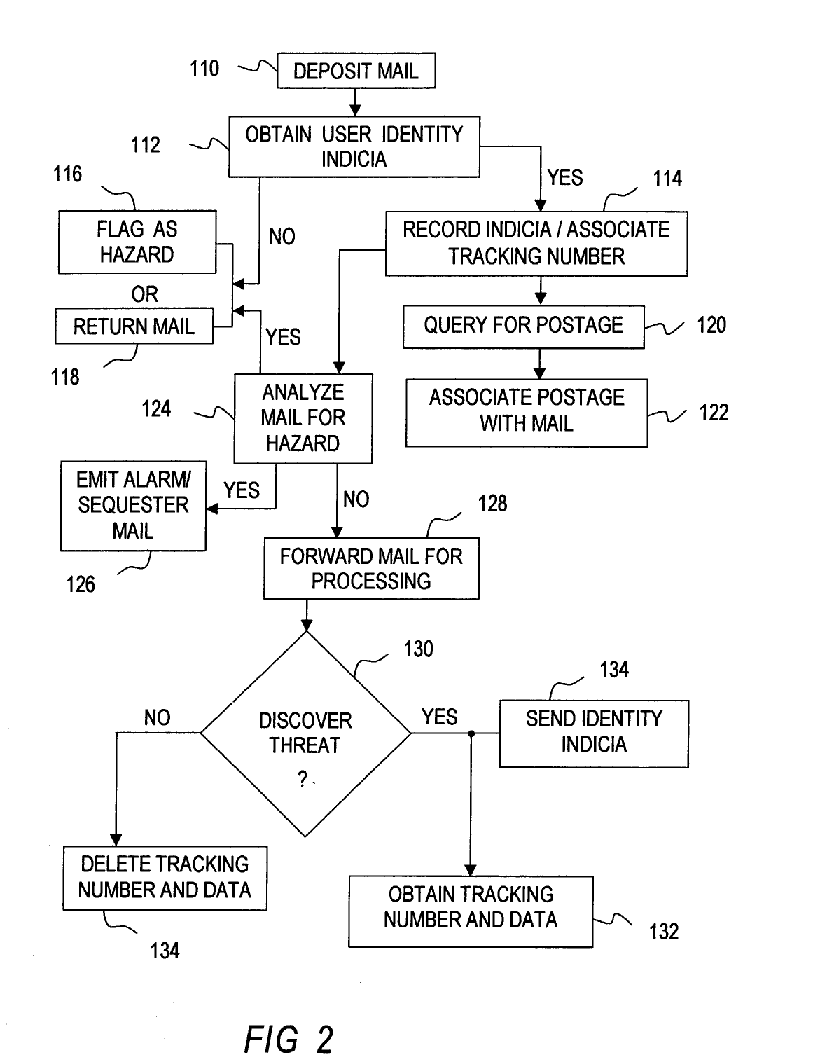

The self-authenticating method also contemplates additional safety options and user conveniences. One such process variation is set forth in FIG. 2. In one enhanced variation of the method, mail is deposited 110 into a suitable quarantined holding area. User identity indicia is obtained 112. A tracking number is associated with the recorded identity indicia and deposited mail 114. In the event that the user declines to submit identity indicia, the deposited mail can be flagged as a hazard 116 or returned to the user 118 for processing in a conventional post office or parcel delivery service where other appropriate safety measures can be implemented.

In addition to obtaining user identity indicia at 112, the self-authenticating method as outlined in FIG. 2 can include appropriate steps for querying the user for postage or other information as indicated at reference numeral 120. In this variation of the self-authenticating method, it is contemplated that the associated device or mechanism could include appropriate apparatus for receiving postage payment, specifying delivery method preference and the like. In the method disclosed, the postage indication, delivery method, etc., can be associated with the deposited mail 122 by a suitable mechanism such as an associated postage meter, printing device, and the like.

While the mail is maintained in the quarantine holding area, the mail can be analyzed for potential hazard(s) as indicated at 124. The self-authenticating method contemplates that such analysis can occur by any suitable method. One example of such method(s) would include performing an investigational scan or scans on the deposited mail contained within the quarantined holding area. To accomplish this, the quarantine holding area includes at least one sensor device or other suitable scanning apparatus which is capable of performing at least one investigational scan on the deposited mail contained therein. The investigational scan may be directed toward detection of a specific undesirable substance or class of undesirable substances associated with the deposited mail. For example, the undesirable substance may be trace amounts of material deposited on the exterior of the package and/or trace amounts of material detected through the packaging and contained within the package itself. The investigational scan may be configured to detect at least one hazard such as a biological hazard, an environmental hazard, a chemical hazard and/or a public safety hazard. The term “biological hazard” as used herein is employed to include, but not be limited to, infectious agents and the like. Such infectious agents can include viruses, spores, and other material detrimental to human beings or other life forms. “Environmental hazards” as that term is employed herein includes material which could be utilized in contaminating soil, water or the like. Such materials can include chemicals, biohazards, and the like. “Chemical hazards” include, but are not limited to agents which can cause physical harm such as corrosives, explosives, radioactive substances and the like. Thus, it is to be understood that while the investigation scan is contemplated to reveal biological hazards, chemical hazards and/or environmental hazards, some overlap between the two types of hazards is contemplated and acceptable. The term “public safety hazards” is employed to include explosive materials, bombs, and other damaging agents. Detection of an undesirable substance can result in the emission of a suitable warning signal which can be transmitted to appropriate authorities according to any appropriate safety protocol as in reference numeral 126. It is also contemplated that the deposited mail on or in which a biological, environmental or physical safety hazard has been detected can be suitably sequestered to prevent additional contamination or danger. It is also contemplated that the positive detection of a hazardous material can trigger the retention and forwarding of tracking data and user identity indicia to assist in resolution of any potential threat posed by the deposited mail.

Where analysis indicates no detectible threat, the mail can be forwarded for appropriate processing and transport through the designated or desired channels. If a threat is discovered at a later point 130, the associated tracking number and data can be sent or obtained to assist in resolution of the threat 134.

If no threat develops or is detected 130, the tracking number and associated data can be deleted after an appropriate archival interval 134. It is contemplated that, in order to maintain privacy and prevent tampering, the tracking number and associated identity indicia will be subjected to appropriate encryption and sequestration to prevent unauthorized access. The sequestered data will be maintained as such until receipt of an appropriate authorized command to forward or release identity indicia associated with a given tracking number to an appropriate authority. It is contemplated that such an authorized send command 132 would be obtainable and associated with appropriate orders and other appropriate judicial mechanisms protecting secrecy and privacy.

FIG. 3 depicts a schematic representation of a mail depository kiosk 210 which includes a mail intake device 212 and a mail quarantine holding area 214 in communication with the mail intake device. The kiosk 210 includes a device 216 capable of recording at least one identifying indicia of a user depositing a piece of mail in the mail intake device 212 is also associated with the kiosk 210. The device 216 is in electronic communication with a device or tracking number associator 218 capable of associating a suitable tracking number to the piece of deposited mail and to the recorded user identity indicia. The device or tracking number associator 218 can be any suitable electronic or electromechanical mechanism 222 controlled by appropriate operating logic which can assign or associate a suitable tracking number with the two respective elements. Thus, the tracking number associator 218 can function interactively with suitable memory storage mechanisms and appropriately configured control electronics 222 to perform necessary functions associating identity indicia obtained from the indicia receiver 216 with the individual piece of mail contained in quarantine holding area 214. The tracking associator 218 can include appropriate printing mechanisms for imprinting the assigned tracking number on the individual piece of mail held in the quarantine holding area 214. The data storage device 220 can include appropriate architecture and logic for maintaining the tracking number and associated user identity indicia in storage for a suitable archival interval or until appropriately accessed.

To further enhance security of the mail received from the mail depository kiosk 210, the kiosk can include an appropriate scanning device or sensor 224 capable of detecting and analyzing the deposited mail for at least one of biohazards, chemical hazards, or physical safety hazards. Thus, it is contemplated that the device may be capable of detecting trace amounts of target chemicals, recognizable biohazards, or materials typically associated with threats to physical safety. The scanning device or sensor 224 of choice is one which can be capable of interactive communication with the controller 222 to provide an appropriate signal indicating the presence or absence of a suspect material. The controller 222 and, if necessary, memory storage area can be queried to ascertain the level of threat and institute appropriate countermeasures. These countermeasures can include the emission of an appropriate alarm signal which could be transmitted to appropriate authorities external to the mail kiosk 210 depending upon the level of threat. Controller 222 can also programmably associate identity indicia collected by indicia receiver 216 to transmit or collect identity information in the event of an ascertainable threat or hazard. Alarm 226 can be a device which is capable of interactively communicating with an external command and control source to receive data from the kiosk 210 and, as desired or required, initiate appropriate steps to contain the hazard or threat.

The kiosk 210 can also include appropriate clocks and chronometers such as clock 230 to further index the information gathered based on time of deposit, etc. To further enhance the reliability and data received from the kiosk 210, the kiosk can also include an appropriate observational camera 232 which is capable of recording a visual photograph or continuing video of individuals utilizing the kiosk 210. The camera 232 can include appropriate controllers 234 and can be in electronic communication with clock 230 to provide appropriate time indices of use of the device.

It is also contemplated that the mail depository kiosk 210 can include an appropriate user interface 236 capable of permitting appropriate user interactions and transactions with the device. Examples of such interactions and transactions can include, but are not limited to, user specification of the manner of mail delivery, application and purchase of postage, and the like. To this end, it is contemplated that the user interface 236 will be in electronic communication with controller 222.

The kiosk 210 can also include a suitable mail exit bin 238 which can contain and hold mail which has been satisfactorily processed through the kiosk 210. Such exit bin 238 is one which will permit appropriate access by appropriate personnel to collect the deposited and identified mail for subsequent processing and transmission to its ultimate intended destination. It is within the purview of this invention to include multiple exit bins and appropriate routing mechanisms so that mail can be sorted by type, destination, nature of carrier or the like. It is also contemplated that external signaling devices can be associated with the device to provide detectable information that the kiosk 210 has a piece of mail ready for physical pick up.

The kiosk 210 can be positioned at various locations which are desirable and/or convenient for mail collection and delivery. These include, but are not limited to post office locations, service centers, malls, public gathering places and the like.

While the invention has been described in connection with what is presently considered to be the most practical and preferred embodiment, it is to be understood that the invention is not limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as permitted under the law.

What is claimed is:

1. A method for receiving articles, the method comprising the steps of:
maintaining at least one deposited article in a quarantine holding area;
receiving at least one element of identity indicia from an individual depositing the article in the quarantine holding area;
associating a tracking number with the deposited article and with the identity indicia received from the individual;
maintaining a record of the tracking number and the associated identity indicia for a suitable archival interval.

2. The method of claim 1 further comprising the step of associating suitable payment indicia on the deposited article in the quarantine holding area.

3. The method of claim 1 wherein the user indicia includes at least one of name, address, identification number, and physical identification indicia.

4. The method of claim 3 wherein the physical identification indicia includes at least one of facial identification registration, fingerprint, and retinal scan.

5. The method of claim 3 further comprising the step of:
associating at least one element of user-inputted information regarding the deposited article, the user inputted information including at least one of delivery fee payments, and delivery method preference.

6. The method of claim 1 further comprising the step of performing at least one investigational scan of the deposited article contained within the quarantine holding area, wherein the quarantine holding area includes at least one sensor device, the sensor device capable performing at the least one investigational scan on the deposited article contained therein.

7. The method of claim 5 wherein the investigational scan is directed toward detection of at least one undesirable substance associated with the deposited article.

8. The method of claim 6 wherein the investigational scan is directed toward detection of at least one of biological hazards, environmental hazards, and physical safety hazards.

9. The method of claim 6 further comprising the step of emitting at least one warning signal upon receipt of positive detection of at least one undesirable substance.

10. The method of claim 1 further comprising the step of printing the tracking number on the deposited article.

11. The method of claim 1 further comprising the step of routing the deposited article according to a predetermined protocol upon assignment of the tracking number.

12. The method of claim 1 further comprising the step of sequestering identity indicia data, wherein the sequestration step is maintained until receipt of an authorized divulgement command.

13. The method of claim 1 further comprising the steps of:
sequestering personal indicia data, the sequestration step is maintained for the archival interval;
upon expiration of the archival interval, purging personal indicia.

14. The method of claim 1 further comprising the step of routing the deposited article to a user-designated carrier, the routing method occurring after assignment of the tracking number.

15. A method for receiving mail, the method comprising the steps of:
receiving at least one piece of deposited mail in a mail service kiosk from a user, the mail service kiosk including at least one user interface, at least one mail depository inlet, at least one quarantine holding area in communication with the mail depository inlet, and at least one mail depository outlet;
maintaining the deposited mail in the quarantine holding area for an interval to access hazards associated with the deposited mail;
while the deposited mail is maintained in the quarantine holding area, receiving at least one element of identity indicia from the user depositing the piece of mail;
associating a tracking number to the deposited mail and to the identity indicia received from the user;
after the tracking number is associated, permitting the mail to exit the depository outlet for further processing and delivery;
maintaining a record of the tracking number and the associated identity indicia for a suitable archival interval.

16. The method of claim 15 further comprising the step of printing the tracking number on the deposited mail prior to exit from the mail service kiosk.

17. The method of claim 15 further comprising the step of receiving user inputted payment instructions by means of the user interface.

18. The method of claim 17 further comprising the step of affixing a suitable payment indicator on the deposited mail.

19. The method of claim 18 wherein the payment indicator is imprinted on the deposited mail.

20. The method of claim 15 wherein the identify indicia includes at least one of name, address, identification number, and physical identification indicia.

21. The method of claim 20 wherein the physical identification indicia includes at least one of facial identification registration, fingerprint, and retinal scan.

22. The method of claim 20 wherein at least one physical identification indicia is ascertained by at least one device associated with the mail service kiosk.

23. The method of claim 22 wherein the at least one device provides identity indicia data in a suitable storable form.

24. The method of claim 15 further comprising the step of performing at least one investigational analysis on the mail deposited in the mail service kiosk.

25. The method of claim 24 wherein the investigational analysis occurs in the quarantine holding area, and wherein the quarantine holding area includes at least one sensor device, the sensor device capable of performing at least one investigational scan on the deposited mail contained therein.

26. The method of claim 24 wherein the investigational scan is directed toward detection of at least one of biological hazards, environmental hazards, and physical safety hazards.

27. The method of claim 24 further comprising the step of emitting at least one warning signal upon receipt of positive detection of at least one undesirable substance.

28. The method of claim 15 further comprising the steps of:
sequestering identity indicia data for the archival interval;
upon expiration of the archival interval, purging identity indicia.

29. The method of claim 28 further comprising the step of sequestering personal indicia data, wherein the sequestration step is maintained until receipt of an authorized divulgement command.

30. A mail depository device comprising;
a housing having at least one mail receiving inlet and at least one mail outlet;
at least one mail quarantine holding area in communication with the mail-receiving inlet;
at least one device capable of recording at least one identity indicia associated with a user depositing a piece of mail in the mail-receiving inlet;
at least one device associating a suitable tracking number with the piece of deposited mail and with the user identity indicia recorded by the recording device.

31. The mail depository deice of claim 30 further comprising at least one user interface device capable of interactive transaction with the user.

32. The mail depository device of claim 30 further comprising at least one device capable of interactive communication with an external command and control source.

33. The mail depository device of claim 30 further comprising at least one data storage device, the data storage device capable of maintaining the suitable tracking number and user identifying indicia for a suitable archival interval.

34. The mail depository device of claim 30 wherein the device capable of recording at least one user identity indicia is capable of analyzing and recording at least one of name, address, identification number, and physical identification indicia.

35. The mail depository device of claim 34 wherein the physical identification indicia includes at least one of facial feature registration, fingerprint, and retinal scan.

36. The mail depository device of claim 30 further comprising a sensor device located in the quarantine holding area, the sensor device capable of detecting at least one hazardous substance associated the deposited mail.

37. The mail depository device of claim 36 further comprising at least one device capable of emitting at least one warning signal upon receipt of positive detection of at least one hazardous substance.

38. The mail depository device of claim 30 further comprising at least of device capable of printing the tracking number on the deposited mail.

39. Apparatus for receiving mail, the apparatus comprising:
means for maintaining at least one deposited article of mail in a quarantine holding area;
means for receiving at least one element of identity indicia from an individual depositing the article of mail;
means for associating a tracking number with the deposited article of mail and with the identity received from the individual;
means for maintaining a record of the tracking number and the identity indicia for a suitable archival interval.

40. The apparatus of claim 39 further comprising means for associating at least one element of user-inputted information regarding the deposited article, the user-inputted information including at least one of delivery fee payments and delivery method preference.

42. The apparatus of claim 39 further comprising means for performing at least one investigational scan on the deposited article of mail.

43. The apparatus of claim 39 further comprising means for printing the tracking number on the deposited article of mail.

44. The apparatus of claim 39 further comprising means for sequestering identity indicia.
